(19) United States
(12) Patent Application Publication
(10) Pub. No.: US 2003/0036297 A1
(43) Pub. Date: Feb. 20, 2003

(54) Snap-in assembly for multiple high current conductive lines

(76) Inventors: Stephen W. Kilkenny, Menomonee Falls, WI (US); Edward G. Butte, Pewaukee, WI (US); Perry Pabich, Jackson, WI (US); Michael Pabich, Brookfield, WI (US)

Correspondence Address: Bank of America Plaza, Suite 2020, 414 Union Street, Nashville, TN, 37219, US

(21) Appl. No.: 10/206,376

(22) Filed: Jul. 26, 2002

Related U.S. Application Data
(60) Provisional application No. 60/309,456, filed on Aug. 1, 2001.

(51) Int. Cl. H01R 25/00

(52) U.S. Cl. 439/110

(57) ABSTRACT

The present invention provides an assembly for attaching a high current conductive line to a support. The assembly comprises a base that includes a first interlocking member and a hanger that includes a second interlocking member removably engaging the first interlocking member. The hanger also includes a retaining section attached to the second interlocking member, wherein the retaining section is shaped to receive and support the conductive line.

### APPLICATION FOR UNITED STATES LETTERS PATENT

This application claims priority to Provisional Patent Application No. 60/309,456 filed on Aug. 1, 2001 and whose contents is expressly incorporated herein by reference.

Be it known that we, Stephen W. Kilkenny, residing in Milwaukee, Wis., Edward G. Butte, residing in Milwaukee, Wis., Perry Pabich, residing in Milwaukee, Wis. and Michael Pabich, residing in Milwaukee, Wis. have invented a new and useful “SNAP-IN ASSEMBLY FOR MULTIPLE HIGH CURRENT CONDUCTIVE LINES”.

### BACKGROUND OF THE INVENTION

The present invention relates generally to an assembly for attaching high current conductive lines to a support.

### DESCRIPTION OF THE PRIOR ART

The current invention is an assembly designed to removably engage multiple high current conductive lines. The design of the current invention allows the user of the assembly to have numerous options for the location of the assembly along a support in order to secure several high current conductive lines to the support. Also, the design of the assembly allows multiple high current conductive lines to be secured to the support in several configurations.

There exists contemporary devices used to attach high current conductive lines, or bus bars, to supports. However, these prior art devices have several inadequacies. For example, these prior art devices are not easily removed from and attached to the high current conductive lines. Also, these prior art devices usually require the device to fit over one end of the conductive line before moving the prior art device to the desired location. As such, a user of a prior art device lacks the option of easily attaching the prior art device to an intermediate location along the length of the conductive line. This causes additional time and effort during installation, removal, or replacement of the prior art devices. This additional time and effort increases cost and difficulties associated with mounting high current conductive lines.

Another advantage of the current invention over the prior art devices is the ability of the current invention to have portions of the current invention replaced without having to remove the entire assembly. This advantage is possible due to the modular slideable connection between the various parts of the current invention. The prior art devices lack this modular interaction and therefore fail to adequately and efficiently support multiple high current conductive lines to a support.

The design of the current invention allows the assembly to not only support the high current conductive lines, but also restrict expansion and movement of the high current conductive lines. This restriction improves the securement of the high current conductive bar to the support.

Due to the lack of adequate devices for attaching high current conductive lines to supports, there is a need in the art for an assembly adapted to removably engage high current conductive electrical lines to a support in an efficient manner.

### SUMMARY OF THE INVENTION

The present invention provides an assembly for attaching a high current conductive line to a support. The assembly comprises a base that includes a first interlocking member and a hanger that includes a second interlocking member removably engaging the first interlocking member. The hanger also includes a retaining section attached to the second interlocking member, wherein the retaining section is shaped to receive and support the conductive line.

The first interlocking member is geometrically configured to accept the second interlocking member. The second interlocking member includes a tapered end that facilitates the insertion of the second interlocking member into the first interlocking member. The retaining section includes a plurality of engagement arms extending from the location of the attachment of the retaining section to the second interlocking member. Each engagement arm is shaped to receive and retain one of the conductive lines.

It is a general object of the present invention to provide an assembly for attaching a high current conductive line to a support.

Another object of the present invention is to provide a removably attaching assembly for retaining a high current conductive line near a support.

Yet another object of the invention is to provide a modular assembly for supporting an electrically conductive bus bar on a support.

Another object of this invention is to provide an assembly that is designed to allow several configurations of attachment for electrically conductive bus bars on a support.

Yet another object of the present invention is to provide an assembly for supporting high current conductive lines that allows replacement of modular components of the assembly.

Still another object of the present invention is to spatially confine a bus bar in order to retain the bus bar near a support.

Still another object of the present invention is to provide an assembly designed to frictionally retain a high current conductive line near a support.

Numerous other objects, features and advantages of the present invention will be readily apparent to those skilled in the art, upon a reading of the following disclosure, when taken in conjunction with the accompanying drawings.

### BRIEF DESCRIPTION OF THE DRAWINGS

FIG. 1 is a front view of the assembly shown retaining multiple conductive lines and engaging the support.

FIG. 2 is similar to FIG. 1. FIG. 2 shows the assembly without the support or the conductive lines and details the hanger and the engagement arms on the hanger.

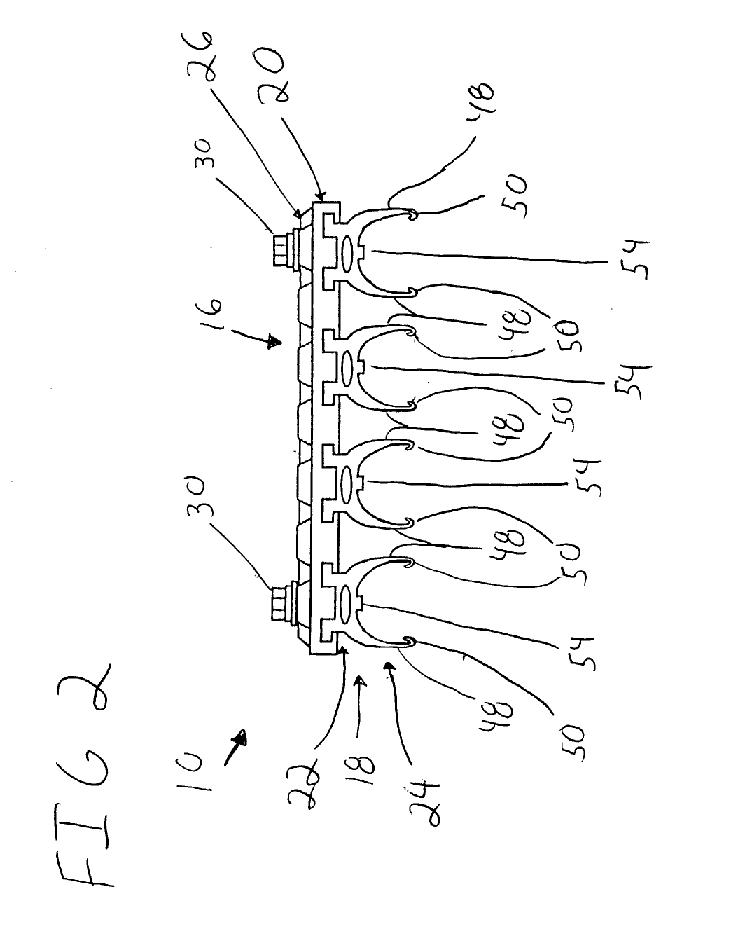

FIG. 3 is perspective view of the assembly showing the modular components of the assembly separated from each other.

FIG. 4 is a perspective view similar to FIG. 3. FIG. 4 shows the modular components of the assembly connected.

FIG. 5 shows a front view of the assembly and the process of engaging the assembly with the conductive lines.

FIG. 6 shows front views of different embodiments of the assembly. Namely, FIG. 6 shows various configurations of the assembly holding 2, 3, or 4 high current conductive lines.

FIG. 7 is a bottom perspective view of the base showing the apertures and the interaction of the apertures and the fasteners.

### DESCRIPTION OF THE PREFERRED EMBODIMENTS

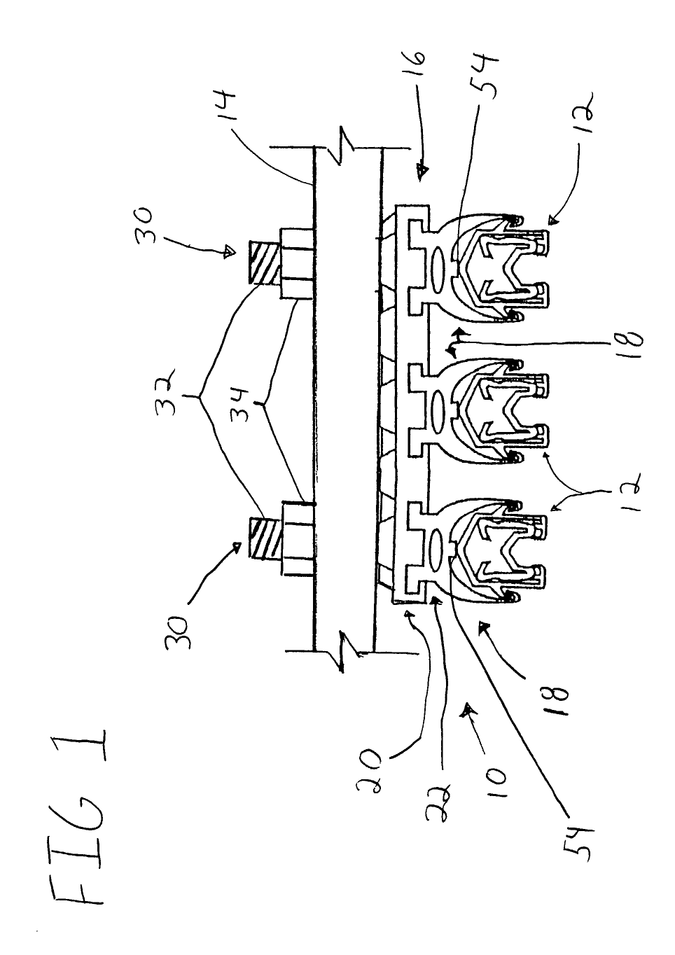

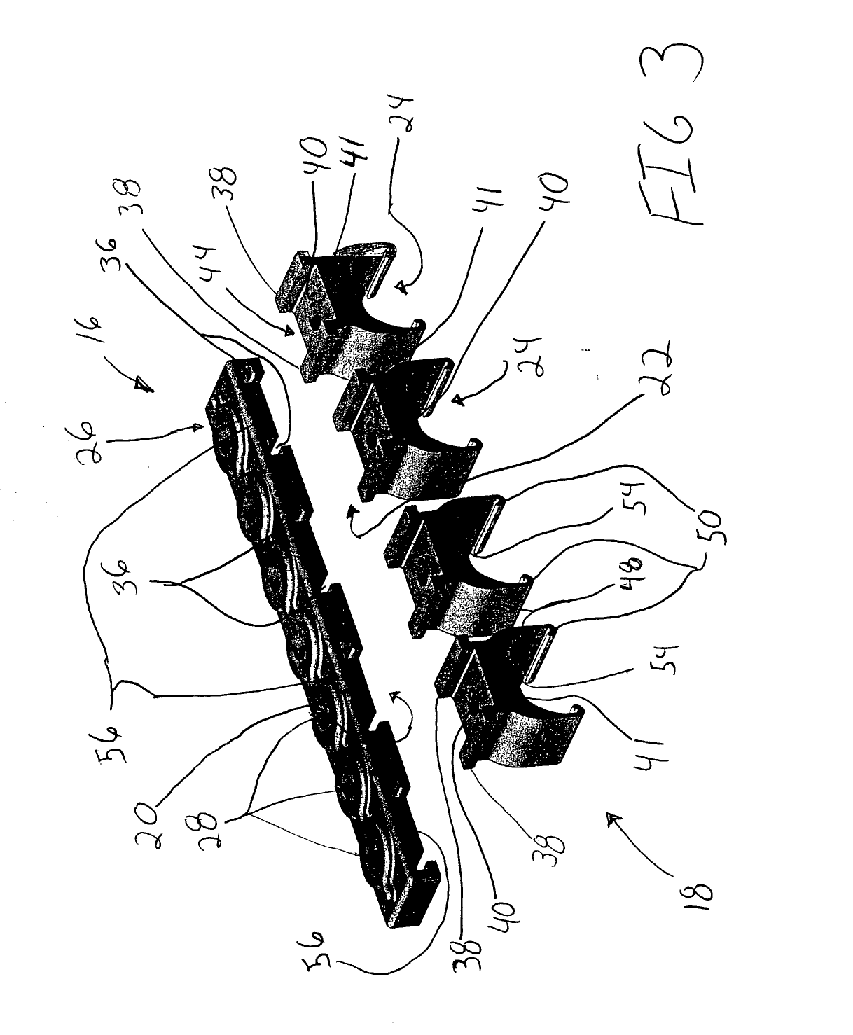

Referring now to FIG. 1, the assembly of the present invention is shown and generally designated by the numeral 10. The assembly 10, also known as a device 10, of the current invention is designed to attach a high current conductive line 12, also known as an electrically conductive bus bar 12, to a support 14. The assembly 10 comprises a base 16 and a hanger 18. The base 16 includes a first interlocking member 20, while the hanger 18 includes a second interlocking member 22 removably engaging the first interlocking member 20. The hanger 18 also includes a retaining section 24 attached to the second interlocking member 22 and shaped to receive and support the conductive line 12. As seen in FIG. 3, the base 16 includes a connection section 26 positioned to connect the base 16 to the support 14. The connection section 26 includes an aperture 28 traversing the base 16 and shaped to accept a fastener 30.

The connection section 26 includes multiple apertures 28 shaped as circular holes and extending through the base 16. Each aperture 28 is shaped to accept a fastener 30. The fastener 30 can be any mounting device known in the art to removably attach an assembly 10 to a support 14. In a preferred embodiment, the fastener 30 comprises a bolt 32 and a nut 34.

The first interlocking member 20 is geometrically configured to accept the second interlocking member 22. The first interlocking member 20 includes channels 36, also called grooves 36, designed to accept the second interlocking member 22. The second interlocking member 22 includes sliding arms 38, also known as tongues 38, designed to fit within the channel 36 of the first interlocking member 20 in order to facilitate engagement between the first interlocking member 20 and second interlocking member 22. In a preferred embodiment the channels 36 and the sliding arms 38 are square in nature. However, both of these features can take on different geometrical configurations and still retain the inventive spirit disclosed herein.

This engagement is further aided by protrusion 40, also called a protuberance 40, located on the second interlocking member 22 and designed to frictionally engage the first interlocking member 20 as the hanger 18 slideable engages the base 16. The protrusion 40 locks the hanger 18 onto the base 16 by entering the aperture 28 that extends through the base 16. The protrusion 40 extends away from the second interlocking member 22 in a slope manner to form a flat surface 41 that extends into the aperture 28 and retains the second interlocking member 22 of the hanger 18 to the first interlocking member 20 of the base 16.

The hanger 18, also known as retaining member 18, is removably attached to the base 16 through the interaction of the second interlocking member 22 on the retaining member 18 and the first interlocking member 20 on the base 16. Specifically, the protuberance 40 removably secures the second interlocking member 22 to the first interlocking member 20.

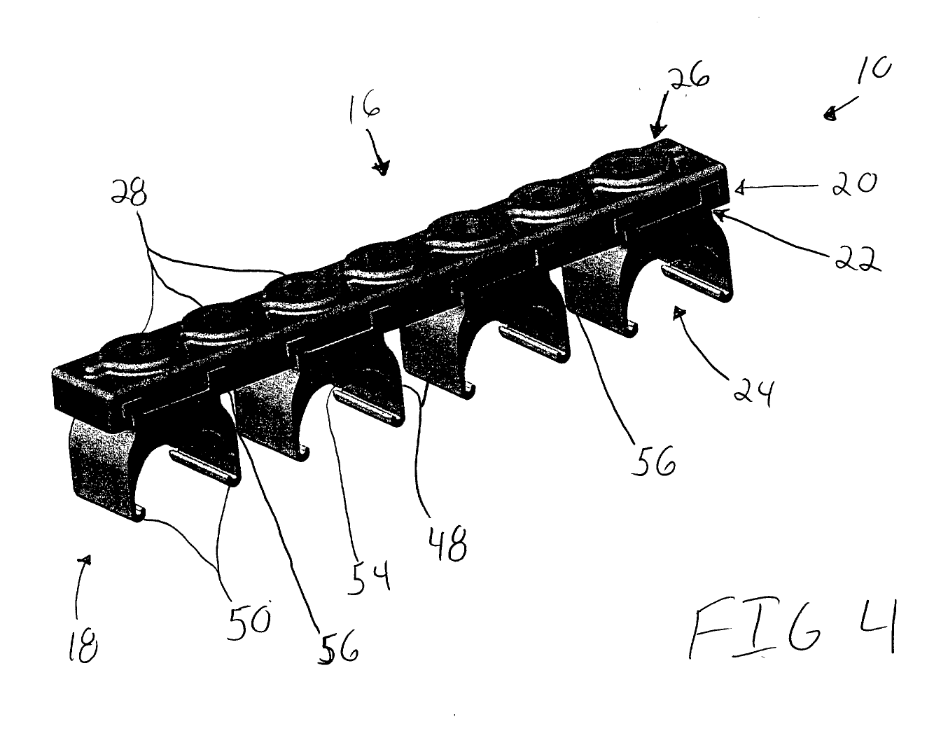

The first interlocking member 20 includes a spacing block 56 spanning between channels 36 and designed to engage the second interlocking member 22. Specifically, the spacing block 56 engages the protrusion 40 as the interlocking members 20 and 22 engage. The protrusion 40 is on passage 44, which is located between sliding arms 38 on the second interlocking member 22. As seen in FIG. 4, when the first interlocking member 20 engages the second interlocking member 22, the channels 36 and spacing block 56 of the first interlocking member 20 properly align with the sliding arms 38 and passage 44 of the second interlocking member 22. The sliding arms 38 include a tapered end 46 allowing insertion of the second interlocking member 22 into the first interlocking member 20. This tapered end 46 further facilitates the interaction between the first interlocking member 20 and the second interlocking member 22.

In an alternate embodiment, the second interlocking member 22 is geometrically configured to accept the first interlocking member 20. The second interlocking member 22 encompasses the first interlocking member 20 to removably engage the hanger 18 to the base 16.

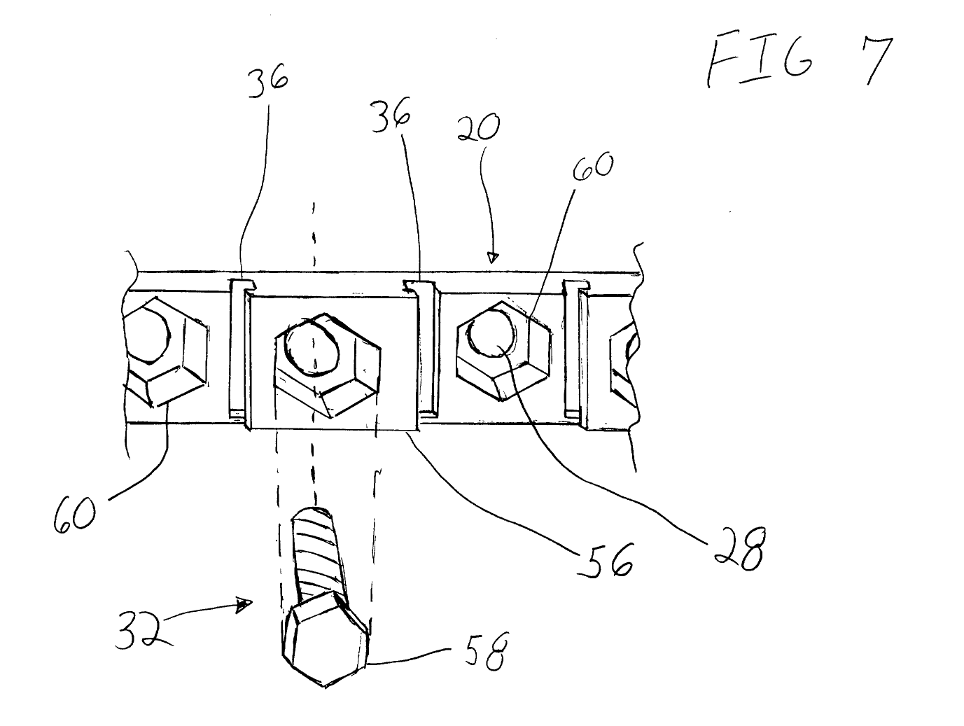

As seen in FIG. 7, the apertures 28 and the base 16 include a hexagon shaped opening in the bottom of the base 16. This hexagon shaped opening 60 mirrors the shape of the head 58 of the bolt 32 of the fastener 30. This hexagon opening 60 further facilitates the attachment of the assembly 10 to a support 14 by restricting the bolt 32 from rotating while the nut 34 is tightened on the bolt 32. Therefore, the engagement between the head 58 of the bolt 32 and the hexagonal opening 60 of the aperture 28 allows the fastener 30 to be secured to the assembly 10 and the support 14 without the need for additional tools to hold the head 58 of the bolt 32.

The retaining section 24 is shaped to receive and support the conductive line 12. The retaining section 24 includes a plurality of engagement arms 48 extending from the location of the attachment of the retaining section 24 to the second interlocking member 22. Each engagement arm 48 is shaped to receive the conductive line 12 and positioned to retain the conductive line 12. Each engagement arm includes a gripping element 50 positioned on the engagement arm 48 to secure the conductive 12 to the retaining section 24.

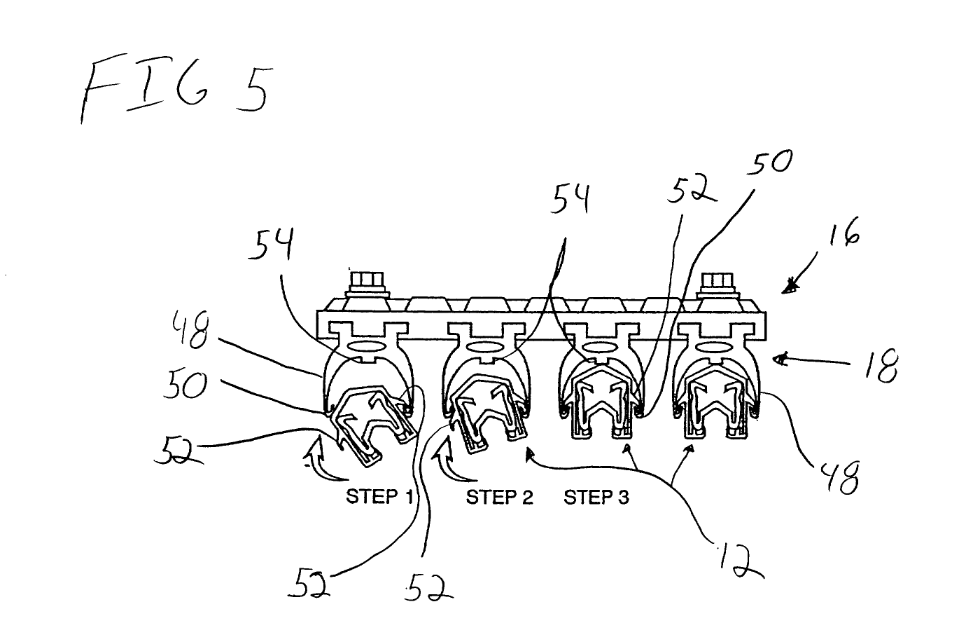

As seen in FIG. 5, the gripping elements 50 on each engagement arm 48 are designed to engage a hook 52 on the conductive line 12. In a preferred embodiment, the gripping element 50 has a hooked shape appearance that corresponds with the hook 52 of the bus bar 12. The gripping elements 50 on the engagement arms 48 are positioned to face each other within the retaining section 24. In alternate embodiments the gripping elements 50 can be positioned to face other gripping elements 50 that are part of adjacent hangers 18 and still support the conductive lines 12.

The gripping element 50 could also engage and support other areas of the conductive 12, including, but not limited to, the bottom, the sides, or the top of the conductive line 12. The retaining section 24 also includes knob 54 designed to engage the top of the conductive line 12 when the conductive line is held within the retaining section 24.

The fact that the retaining section 24, the hanger 18 slideably accepts the conductive line 12 provides the user of the assembly 10 options in the implementation of the assembly 10. For example, the assembly 10 can removably engage an intermediary portion of the conductive line 12 without having to insert the hanger 18 on one end of the conductive line 12 and then move the hanger 18 to the desired location for support. The ability of the assembly 10 to be positioned at any desired location along the length of the conductive line 12 allows the user of the assembly line 10 to have numerous options in deciding the placement of the assembly 10 in order to attach the conductive line 12 to a support 14.

The freedom to easily attach the assembly 10 at numerous locations along the conductive line 12 is further enhanced by the ability of the assembly 10 to accept the conductive line 12 into the retaining section 24 by “snapping in” the conductive line 12 into the retaining section 24. As seen in FIG. 5, the ease of the implementation of the assembly 10 to support conductive lines 12 is further facilitated by the design of the retaining section 24 and the flexibility in the engagement arms 48. FIG. 5 shows the insertion of the conductive lines 12 into the retaining section 24. First, one of the hooks 52 on a conductive line 12 is engaged with a gripping element 50 on one of the engagements arms 48. Next, the conductive line 12 is pressed up into the retaining section 24 until the other hook 52 on the conductive line 12 engages the gripping element 50 on the other engagement arm 48 in the retaining section 24. As seen in step 2 and step 3 of FIG. 5, once the other hook 52 of the conductive line 12 clears the other gripping element 50 of the other engagement arm 48, the conductive line 12 snaps into place and is held between the engagement arms 48 and the knob 54 of the retaining section 24.

Also, the assembly 10 can retain the conductive line 12 in virtually any plane. This allows great freedom by the user of the assembly 10 to locate the conductive line 12 near numerous different supports 14. For example, the support 14 can be any structure to which a user of the assembly 10 wishes to attach the conductive line 12, including, but not limited to, walls, posts, equipment, machines, and the like.

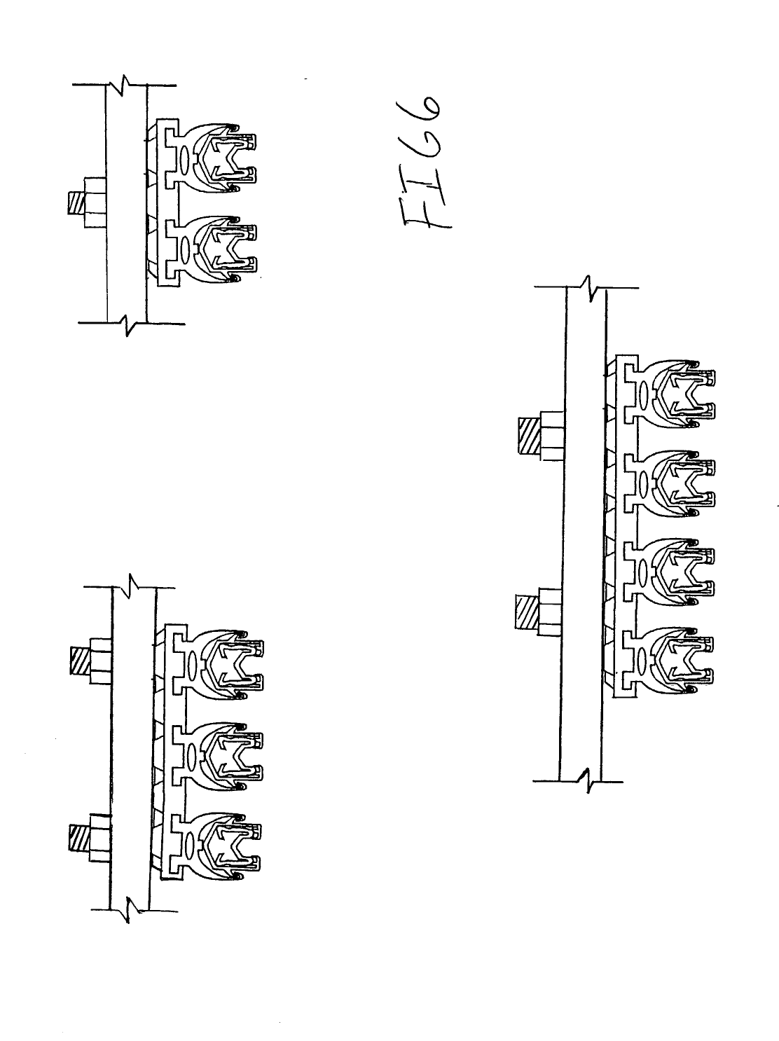

The base 16 has numerous apertures 28 along the length of the base 16. As seen in FIG. 4, some at the apertures 28 are positioned along the base 16 above each of the first interlocking members 20 along the base 16. Other apertures 28 traverse the base in positions located between the interlocking members 20. This spacing of the apertures 28 allows numerous configurations of fasteners 30 to be used in association with assembly 10. As seen in FIG. 6, the fasteners 30 can be positioned directly over a hanger 18 that is holding a conductive line 12 or the fasteners 30 can be positioned over spacing block 56 located between the first interlocking members 20.

As seen in FIG. 6, the assembly 10 can have various configurations that include the ability to support multiple conductive lines 23. The modular nature of the assembly 10 provides the base 16 the capability of supporting at least two hangers 18. In FIG. 6, four hangers 18 are shown attached to the base 16. This should not be a limiting feature of the assembly 10 and numerous other hangers 18 can be attached to a single base 16 and still retain the ideals of this invention.

The modular concept facilitates easier replacement of parts of the assembly 10 that may be broken or damaged, easier construction of the assembly 10, lower cost of installation and manufacturing of the assembly 10, versatility in the configuration of the assembly 10. The modular configuration of the assembly 10 also allows for the mounting of multiple links of conductive lines 12 as desired by user of the assembly 10.

In a preferred embodiment the assembly 10 is composed of materials resistant to electricity and ultraviolet light. For example, plastic is any ideal material in which to compose the assembly 10. The centers of the first interlocking members 20 are 1.75 inches apart and the centers of the apertures are 0.875 inches apart.

A method for supporting a bus bar 12 is also taught. The method comprises removably attaching the bus bar 12 to a retaining member 18 and removably attaching the retaining member 18 to a base 16. The method further includes spatially confining the bus bar 12 with the retaining member 18 to vertically support the bus bar 12. The spatial configuration occurs through the engagement arms 48 and knob 54 of the retaining section 24 engaging the conductive line 12. As the conductive line 12 is placed into the retaining section 24 of the retaining member 18, the engagement arms 48 and knob 54 effectively squeeze around the bus bar 12 to frictionally engage and spatially confine the bus bar 12 within the retaining member 18.

The method further includes sliding the retaining member 18 into engagement with the base 16. This is accomplished through the interaction of the first interlocking member 20 on the base 16 and the second interlocking member 22 on the retaining member 18. Specifically, the tongue 38 of this second interlocking member 22 engages the groove 36 of the first interlocking member 20 to facilitate the sliding engagement. The method further includes frictionally securing the retaining member to the base through the use of a protuberance 40 on the second interlocking member 22 that engages the first interlocking member 20.

Thus it is seen that the apparatus and methods of the present invention readily achieves the ends and advantages mentioned, as well as those inherent therein. While certain preferred embodiments of the invention have been illustrated and described for purposes of the present disclosure, numerous changes in the arrangement and construction of parts and steps may be made by those skilled in the art, which changes are encompasses within the scope and spirit of the present invention as defined by the appended claims.

What is claimed is:

1. An assembly for attaching a high current conductive line to a support, comprising:
a base including a first interlocking member; and
a hanger including a second interlocking member removably engaging the first interlocking member and a retaining section attached to the second interlocking member, the retaining section shaped to receive and support the conductive line.

2. The assembly of claim 1, wherein the first interlocking member is geometrically configured to accept the second interlocking member.

3. The device of claim 2, wherein the second interlocking member further includes a tapered end allowing insertion of the second interlocking member into the first interlocking member.

4. The assembly of claim 1, wherein the second interlocking member includes a protrusion to removably lock the second interlocking member to the first interlocking member.

5. The assembly of claim 1, wherein the base includes a connection section positioned to connect the base to the support.

6. The assembly of claim 5, wherein the connection section includes an aperture traversing the base and shaped to accept a fastener.

7. The assembly of claim 1, wherein the retaining section includes a plurality of engagement arms extending from the location of the attachment of the retaining section to the second interlocking member, each engagement arm shaped to receive the conductive line and positioned to vertically retain the conductive line.

8. The assembly of claim 6, wherein each engagement arm includes a gripping element positioned on the engagement arm to secure the conductive line to the retaining section.

9. A device for attaching an electrically conductive bus bar on a support, comprising:
a base including a first interlocking member and a connection section positioned to connect the base to the support, the connection section including an aperture traversing the base and shaped to accept a fastener; and
a retaining member removably attached to the base and including a second interlocking member frictionally attached to the first interlocking member, the second interlocking member including a protuberance removably securing the second interlocking member to the first interlocking member; and
a retaining section including at least one engagement arm shaped to receive the bus bar and positioned to vertically retain the bus bar in the retaining section.

10. The device of claim 9, wherein the second interlocking member further includes a tapered end allowing insertion of the second interlocking member into the first interlocking member.

11. The assembly of claim 9, wherein each engagement arm includes a gripping element positioned on the engagement arm to secure the bus bar to the retaining section.

12. A method for supporting an electrically conductive bus bar, comprising:
a) removably attaching the bus bar to a retaining member; and
b) removably attaching the retaining member to a base.

13. The method of claim 12, wherein step a) further includes spatially confining the bus bar with the retaining member to vertically support the bus bar.

14. The method of claim 12, wherein step b) further includes sliding the retaining member into engagement with the base.

15. The method of claim 12, wherein step b) further includes frictionally securing the retaining member to the base.
